(19) United States
(12) Patent Application Publication
(10) Pub. No.: US 2012/0148320 A1
(43) Pub. Date: Jun. 14, 2012

(54) FUSING APPARATUS AND IMAGE FORMING APPARATUS HAVING THE SAME

(75) Inventors: Young-hoon Han, Suwon-si (KR); Soo-hwan Bae, Seoul (KR)

(73) Assignee: SAMSUNG ELECTRONICS CO., LTD., Suwon-si (KR)

(21) Appl. No.: 13/307,697

(22) Filed: Nov. 30, 2011

(30) Foreign Application Priority Data
Dec. 14, 2010 (KR) 10-2010-0127698

(51) Int. Cl. G03G 15/20

(52) U.S. Cl. 399/331

(57) ABSTRACT

A fusing apparatus including a heating roller supplying heat onto a printing medium; a first pressure roller forming a first fusing nip by contacting a heating roller; a second pressure roller forming a second fixing nip by contacting the heating roller; a frame on which the heating roller, the first pressure roller and the second pressure roller are installed; and at least one bending reducing roller that reduces the bending of the second pressure roller by supporting a part of the second pressure roller in the lengthwise direction is provided.

### CROSS-REFERENCE TO RELATED APPLICATIONS

This application claims the priority benefit of Korean Patent Application No. 2010-0127698 filed on Dec. 14, 2010, in the Korean Intellectual Property Office, the disclosure of which is incorporated herein by reference.

### BACKGROUND

1. Field

Embodiments relate to an image forming apparatus, and more particularly, to a fusing apparatus used in an image forming apparatus.

2. Description of the Related Art

An image forming apparatus such as a printer, a facsimile machine, a copier, and a multifunction peripheral forms a predetermined image on a printing medium using electro photography. Such an image forming apparatus generally carries out a charging process, a laser scanning process, a developing process, a transferring process, and a fusing process, in order to form an image.

In the fusing process, a fusing apparatus generally applies heat and pressure onto a printing medium and fuses toner which is not fused on a printing medium. In general, the fusing apparatus includes a heating roller and a pressure roller. By the contact between the heating roller and the pressure roller, a fusing nip is formed between the heating roller and the pressure roller. While the printing medium passes the fusing nip, heat and pressure are transmitted onto the printing medium, thereby fusing the non-fused toner.

Recently, there is an effort to minimize an image forming apparatus. Accordingly, there is an effort to minimize a fusing apparatus of the image forming apparatus. To achieve this, a pressure roller is also becoming minimized. To form a fusing nip, the pressure roller is affected by a certain pressure and the pressure roller may be significantly bent as the pressure roller becomes minimized. If the pressure roller is bent, fusing capability of a toner is lowered because a uniform fusing-nip is not formed. In addition, if the pressure roller is operated for a long time in a largely bent status, abrasion occurs on the surface of the pressure roller and heating roller which contacts with the pressure roller. Therefore, a fusing apparatus which may prevent the pressure roller from a large amount of bending is needed.

### SUMMARY

An aspect of one or more embodiments relates to a fusing apparatus which is capable of preventing a pressure roller from being significantly bent.

A fusing apparatus, according to an aspect of one or more embodiments, includes a heating roller which supplies heat onto a printing medium; a first pressure roller which forms a first fusing nip by contacting the heating roller; a second pressure roller which forms a second fusing nip by contacting the heating roller; a frame where the heating roller, the first pressure roller, and the second pressure roller are mounted; and at least one bending reducing roller which reduces bending of the second pressure roller by supporting a part of the second pressure roller in a lengthwise direction.

The second pressure roller may have a smaller diameter than the first pressure roller.

The at least one of the bending reducing rollers may include a first bending reducing roller, wherein the first bending reducing roller may support a center part of the second pressure roller in the lengthwise direction.

The at least one of the bending reducing rollers may include a first and a second bending reducing rollers, wherein the first bending reducing roller may support the point that is ⅓ length of the second pressure roller apart from one end of the second pressure roller, wherein the second bending reducing roller may support the point that is ⅓ length of the second pressure roller apart from the other end of the second pressure roller.

A first support for the first bending reducing roller that may rotatably support rotation axis of the first bending reducing roller, and a second support for the second bending reducing roller that may rotatably supports rotation axis of the second bending reducing roller.

A first elastic member that may be connected to the first support and the frame and that may change power that is applied to the second pressure roller by the first bending reducing roller according to the bending of the second pressure roller and the first support, and a second elastic member that may be connected to the second support and the frame and that may change power that is applied to the second pressure roller by the second bending reducing roller according to the bending of the second pressure roller and the second support.

An elastic layer may be formed on a surface of the at least one of the bending reducing rollers.

The fusing apparatus may further include a support that rotatably supports rotation axis of the at least one of the bending reducing rollers.

The fusing apparatus may further include an elastic member that may be connected to the support and the frame and changes power that is applied to the second pressure roller by the bending reducing roller, according to the bending of the second pressure roller and the support.

The elastic member may be installed in a slot which is formed on the frame.

The support may be installed on the frame.

The fusing apparatus may further include a guide member that may be rotatably connected to the frame.

The fusing apparatus may further include an elastic member that may be connected to the support and the guide member and changes the power that is applied to the second pressure roller by the bending reducing roller, according to the bending of the second pressure roller.

The elastic member may be deployed in the slot which is formed on the guide member.

The support may be installed on the guide member.

One or more supports and a frame may be integrally formed.

The first and the second pressure rollers may be made of the same material, and the hardness of the second pressure roller 132 may be less than that of the first pressure roller.

An image forming apparatus, according to another aspect of one or more embodiments may include a fusing apparatus which has characters as above mentioned.

### BRIEF DESCRIPTION OF THE DRAWINGS

Reference will now be made in detail to embodiments, examples of which are illustrated in the accompanying drawings, wherein like reference numerals refer to the like elements throughout. Embodiments are described below to explain the present disclosure by referring to the figures, in which:

FIG. 1 is a schematic view illustrating an image forming apparatus according to an embodiment;

FIG. 2 is an enlarged view illustrating a fusing apparatus of FIG. 1;

FIG. 3 is a schematic view of the rollers built inside the fusing apparatus of FIG. 1;

FIG. 4 is a view of a shear force diagram and bending moment diagram of a second pressure roller according to the existence of a bending reducing roller;

FIG. 5 is a schematic view showing an embodiment of a fusing apparatus;

FIG. 6 is a schematic view showing an embodiment of a fusing apparatus; and

FIG. 7 is a schematic view showing an embodiment of a fusing apparatus.

### DETAILED DESCRIPTION

Embodiments are described in detail below with reference to the accompanying drawings.

In the following description, like drawing reference numerals are used for the like elements, even in different drawings. The matters defined in the description, such as detailed construction and elements, are provided to assist in a comprehensive understanding of embodiments. However, embodiments can be practiced without those specifically defined matters. Also, well-known functions or constructions are not described in detail since they would obscure the application with unnecessary detail.

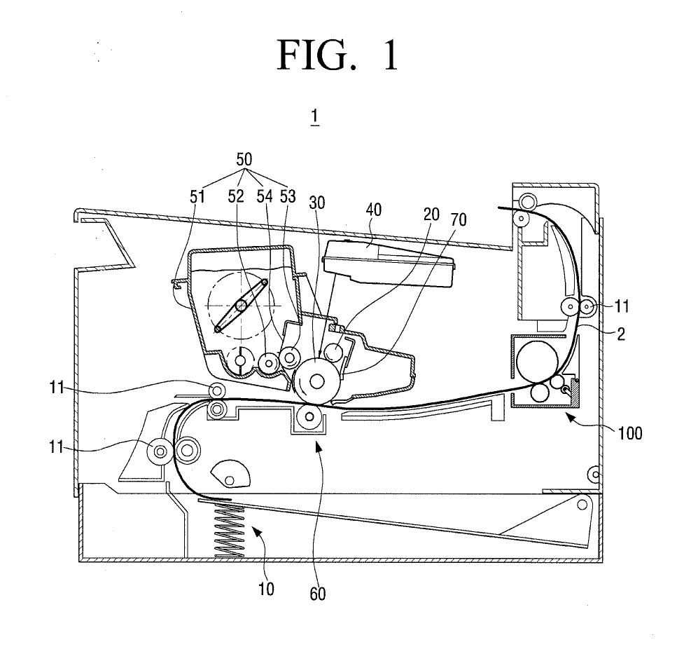

FIG. 1 is a schematic view illustrating an image forming apparatus 1 according to an embodiment. The image forming apparatus 1 may be diverse apparatuses for forming a predetermined image on a printing medium such as printers, facsimile machines, copiers, and multifunction peripherals.

A paper feeding apparatus 10 may store the printing medium such as a paper therein. The printing medium is conveyed by a plurality of conveyance rollers 11 along an advancing path 2. A charging apparatus 20 may electrically charge a photoconductive medium 30 at a predetermined potential. A laser scanning apparatus 40 may scan the surface of the photoconductive medium 30 with light, thereby forming an electrostatic latent image corresponding to printing data on the surface of the photoconductive medium 30.

A developing apparatus 50 may supply toner to the surface of the photoconductive medium 30 on which the electrostatic latent image is formed, thereby forming a toner image. The developing apparatus 50 may include a toner container 51, a toner supply roller 52, a developing roller 53, and a regulation blade 54.

The toner container 51 contains toner therein. The toner supply roller 52 supplies the toner contained in the toner container 51 to the developing roller 53, thereby forming a toner layer on the developing roller 53. The regulation blade 54 makes the toner layer uniform. The toner layer formed on the developing roller 53 is moved to the electrostatic latent image formed on the surface of the photoconductive medium 30 due to a potential difference such that the toner image is developed.

A transferring apparatus 60 may transfer the toner image formed on the surface of the photoconductive medium 30 to the printing medium. A cleaning apparatus 70 may remove toner remaining on the surface of the photoconductive medium 30 after the transferring process.

A fusing apparatus 100 may apply heat and pressure to the printing medium, thereby fusing a non-fused toner remaining on the printing medium. The printing medium on which the toner is fused is discharged to an outside of the image forming apparatus 1 by a plurality of conveyance rollers 11, thereby completing a printing process.

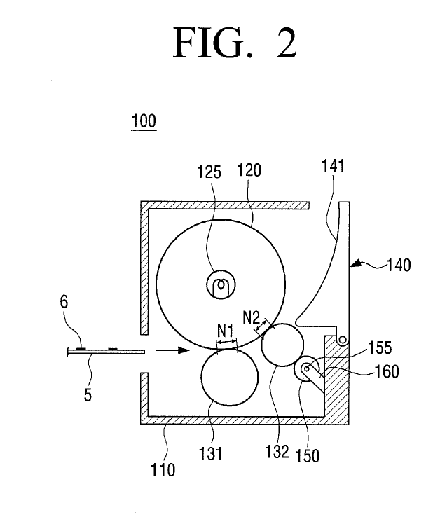

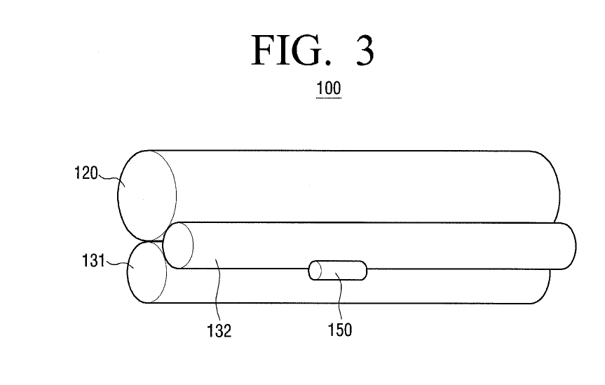

With reference to FIGS. 2 and 3, an embodiment of the fusing apparatus 100 will be described.

FIG. 2 is an enlarged view of a fusing apparatus 100 illustrated in FIG. 1, and FIG. 3 is a schematic view of rollers installed inside the fusing apparatus 100.

Frame 110 forms an external appearance of the fusing apparatus 100 and a heating roller 120, a first pressure roller 131, and a second pressure roller 132 are installed therein. Albeit not shown, the heating roller 120, the first pressure roller 131, and the second pressure roller 132 are rotatably supported on a side wall of the frame 110.

The heating roller 120 supplies heat to a printing medium 5 which passes the fusing apparatus 100. To achieve this, a heating element 125 is arranged inside the heating roller 120. The heating element 125, for example, may be a halogen lamp. Heat created from the heating element 125 is transmitted onto the printing medium 5 through the heating roller 120.

The first pressure roller 131 contacts the heating roller 120 to form a first fusing nip (N1). The first pressure roller 131 is pressed toward the heating roller 120, thereby pressing the printing medium 5 which passes the first fusing nip (N1).

The second pressure roller 132 contacts the heating roller 120 to form a second fusing nip (N2). The second pressure roller 132 is pressed toward the heating roller 120, thereby pressing the printing medium 5 which passes the second fusing nip (N2).

A guide side 141 is formed on a guide member 140 and guides the progress of the printing medium 5. The guide member 140 may be rotatably connected to the frame 110. If a paper jam of the printing medium 5 occurs in the fusing apparatus 100, a user may open the guide member 140 and remove the printing medium 5.

While the printing medium 5 passes the first and the second fusing nips (N1, N2), heat and pressure are applied to the printing medium 5, thereby fusing the non-fused toner 6 on the printing medium 5. In this embodiment, the width of the fusing nip is widened because the two fusing nips (N1, N2) are formed. Accordingly, the heating roller 120 may supply more heat onto the printing medium 5 while the printing medium 5 passes the fusing apparatus 100. Therefore, the fusion capability of the toner 6 may be enhanced and the fusion capability of the toner 6 may not be deterred although the pressure on the printing medium 5 is reduced.

To make the width of the fusing nip broadened, a method of growing the size of the pressure roller is generally used. In an embodiment, it is not necessary to increase the size of pressure roller as the fusing nip is widened by a method of employing the two pressure rollers 131 and 132. Therefore, this embodiment may be helpful to minimize the image forming apparatus 1 and fusing apparatus 100.

To form the first and the second fusing nips (N1, N2), the first and the second pressure rollers 131 and 132 are pressed at a certain level as the first and the second rollers 131 and 132 are pressed toward the heating roller 120. Therefore, the first and the second pressure rollers 131 and 132 may be bent and especially, the most significant bending occurs at the center of the first and the second pressure rollers 131 and 132. Accordingly, a uniform fusing nip is not formed in the lengthwise direction of the first and the second pressure rollers 131 and 132, thereby occurring a lowered toner fusion capability.

In an, embodiment, the second pressure roller 132 has a smaller diameter than the first pressure roller 131. Therefore, if the first and the second pressure rollers 131 and 132 are made of the same material, the hardness of the second pressure roller 132 is less than that of the first pressure roller 131. Accordingly, the bending of the second pressure roller 132 may be more significant than the first pressure roller. In an embodiment, a bending reducing roller 150 is used to ease the bending phenomenon of the second pressure roller 132.

The bending reducing roller 150 supports a part of the second pressure roller 132 in the lengthwise direction, thereby reducing the bending of the second pressure roller 132. As illustrated in FIG. 3, the bending reducing roller 150 supports the middle part of the second pressure roller 132 in the lengthwise direction in an embodiment.

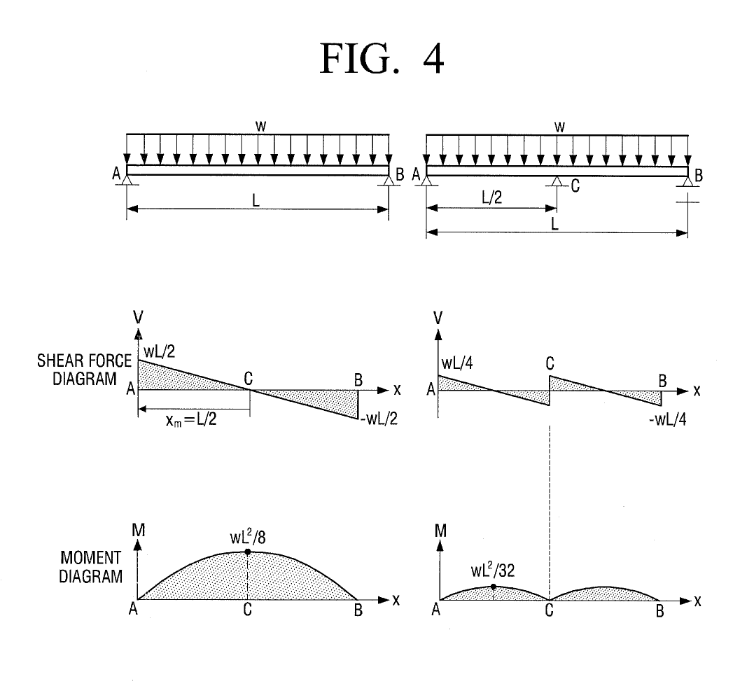

Hereinafter, with reference to FIG. 4, the principle of reducing the bending of the second pressure roller 132 will be described in greater detail.

FIG. 4 illustrates a shear force diagram and a bending moment diagram of the second pressure roller 132, according to the existence of the bending reducing roller 150. The left part of FIG. 4 illustrates a case where the bending reducing roller 150 does not exist. The right part of FIG. 4 illustrates a case where the bending reducing roller 150 exists.

Herein, the second pressure roller 132 is assumed to be a beam under uniform weight (w). In FIG. 4, A and B represents the support points that support both ends of the second pressure roller 132 and the rotation axis of the second pressure roller 132 is sustained by the points on a side wall of the frame 110. In addition, reference mark C represents a point where the bending reducing roller 150 supports the second pressure roller 132. In reality, the bending reducing roller 150 supports a part of the second pressure roller 132. However, for the sake of argument, this embodiment assumes that the second pressure roller 132 is point-supported at the supporting point C by the bending reducing roller 150.

In case where the bending reducing roller 150 does not exist, the shear force diagram and the bending moment of the second pressure roller 132 may be presented as follows:

$$V = \frac{1}{2} wL - wx$$

$$M = \frac{1}{2} wLx - \frac{1}{2} wx 2$$

V represents shear force, M represents bending moment, L represents the length of the second pressure roller 132 and x represents a distance from a support point A.

In this case, as illustrated in FIG. 4, it may be acknowledged that the most significant bending moment of wL2/8 occurs at the center of the second pressure roller 132.

In case where the bending reducing roller 150 exists, the shear force and the bending moment of the second pressure roller 132 may be presented as follows:

$$V = \frac{1}{4} wL - wx ( 0 \leq x < \frac{L}{2} )$$

$$M = \frac{1}{4} wLx - \frac{1}{2} wx 2 ( 0 \leq x < \frac{L}{2} )$$

In this case, as illustrated in FIG. 4, it may be acknowledged that the most significant bending moment of wL2/32 occurs at the point L/4 away from the support points A and B locating on both ends of the second pressure roller 132. Comparing with the case where the bending reducing roller 150 does not exist, bending moment is reduced up to 4 times at most. In this way, the bending reducing roller 150 reduces bending of the second pressure roller 132 by supporting a part of the second pressure roller 132.

In the above description, the bending reducing roller 150 is applied only to the second pressure roller 132 which has relatively weak hardness, however, it should be understood that the bending reducing roller 150 may be applied to the first pressure roller 131. If the size of the pressure roller 131 is getting minimized according to minimization of the fusing apparatus 100, a significant bending may occur on the first pressure roller 131 having relatively strong hardness.

An elastic layer may be formed on the surface of the bending reducing roller 150. The elastic layer may prevent damage on the surface of the second pressure roller 132 contacting the bending reducing roller 150. However, since the formation of the elastic layer on the second pressure roller 132 is general, it is not a problem that the elastic layer is not formed on the bending reducing roller 150 to reduce the cost of materials.

As illustrated in FIG. 2, a support 160 is installed on the frame 110 and rotatably supports a rotation axis 155 of the bending reducing roller 150. The support 160 may be a separate member from the frame 110 and may be combined with the frame 110. Alternatively, the support 160 and the frame 110 may be integrally formed as one body. In general, the frame 110 has great hardness, and thus, the frame 110 may stand stably against the power that the bending reducing roller 150 receives.

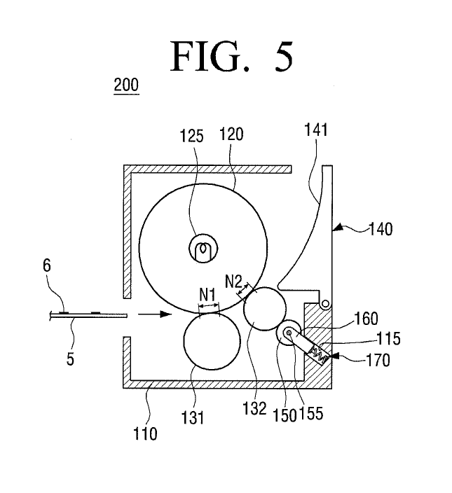

The FIG. 5 is a schematic view of a fusing apparatus 200 according to another embodiment. The components having the same functions and operations as the components explained in aforementioned embodiments are given the same reference marks and a detailed description thereof is omitted.

An elastic member 170 exists in the fusing apparatus 200 illustrated in FIG. 5, which is different from the aforementioned embodiments. The one end of the elastic member 170 is connected to the frame 110 and the other end of the elastic member 170 is connected to the support 160. The elastic member 170 is disposed in a slot 115 formed on the frame 110. For instance, this elastic member 170 may be a spring.

As the elastic member 170 exists, the power applied to the second pressure roller 132 by the bending reducing roller 150 may be controlled, according to the bending level of the second pressure roller 132. In other words, if the second pressure roller 132 is bent significantly, the bending reducing roller 150 applies strong power to the second pressure roller 132 by the elastic member 170 and if the second pressure roller 132 is bent slightly, the bending reducing roller 150 applies weak power to the second pressure roller 132 by the elastic member 170. In this way, since the power applied to the second pressure roller 132 by the bending reducing roller 150 may be changed according to the bending of the second pressure roller 132, it is possible to minimize the damage which may be occurred on the surface of the second pressure roller 132 and reduce the bending of the second pressure roller 132.

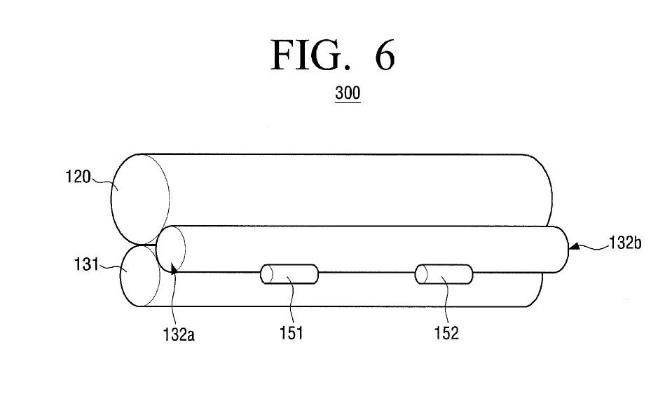

FIG. 6 is a schematic view of a fusing apparatus 300 according to another embodiment.

The fusing apparatus 300 illustrated in FIG. 6 has two bending reducing rollers (151,152), which is different from the above-mentioned embodiments. Herein, the first bending reducing roller 151 supports the point apart ⅓ length of the second pressure roller 132 from one end 132a of the second pressure roller 132 and the second bending reducing roller 152 supports the point apart ⅓ length of the second pressure roller 132 from the other end 132b of the second pressure roller 132. By using the two bending reducing rollers 151 and 152, the maximum bending moment of the second pressure roller 132 may be more reduced, thereby the bending of the second pressure roller 132 may be significantly reduced.

Using the two bending reducing rollers 151 and 152 is just an embodiment and it should be understood that three or more bending reducing rollers may be used if necessary.

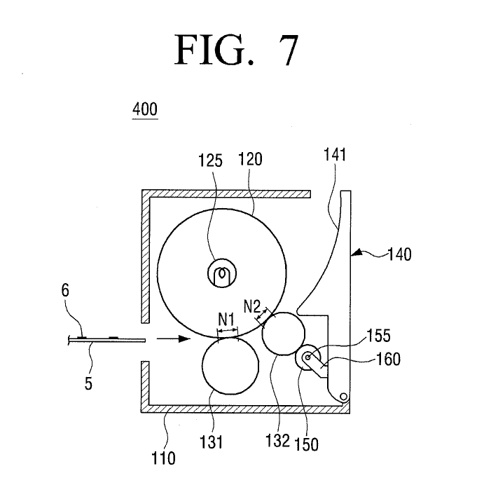

FIG. 7 is a schematic view of a fusing apparatus 400 according to another embodiment.

The installation point of the support 160 of the fusing apparatus 400 illustrated in FIG. 7 is different from the above-mentioned embodiment. In other words, the support 160 is installed on the guide member 140 instead of the frame 110.

Since FIG. 7 is a schematic view of the fusing apparatus 400, an inner composition of the fusing apparatus 400 is relatively simple. In practice, however, various components not illustrated in FIG. 4 are installed in the inner fusing apparatus 400. Accordingly, because of the interference problem with the components existing in the inner fusing apparatus 400, the case where the bending reducing roller 150 may not be installed on the frame 110. In this case, as illustrated in FIG. 7, the bending reducing roller 150 may be installed on the guide member 140. In general, since the guide member 140 is made of plastic that is easy to make form, the guide member 140 is easily deformable. It is possible to make the guide member 140 in such a form that may be installed in the bending reducing roller 150 without interference with the components in the fusing apparatus 400.

Similar to the embodiment illustrated in FIG. 5, it should be understood that the elastic member 170 may be applied to the embodiment of FIG. 7. In other words, it is possible to form a slot on the guide member 140 and install the elastic member 170 within the slot. In this case, the one end of the elastic member 170 is connected to the support 160 and the other end of the elastic member 170 is connected to the guide member 140. The elastic member 170 changes the power applied to the second pressure roller 132 by the bending reducing roller 150, according to the bending of the second pressure roller 132.

Similar to the embodiment illustrated in FIG. 6, it should be understood that a plurality of bending reducing rollers may be applied to FIG. 5 and FIG. 7. By applying the plurality of bending reducing rollers, maximum bending moment of the second pressure roller 132 is reducible, thereby significantly reducing the bending of the second pressure roller 132.

Although embodiments have been shown and described, it would be appreciated by those skilled in the art that changes may be made in these embodiments without departing from the principles and spirit of the disclosure, the scope of which is defined in the claims and their equivalents.

What is claimed is:

1. A fusing apparatus, comprising:
a heating roller which supplies heat onto a printing medium;
a first pressure roller which forms a first fusing nip by contacting the heating roller;
a second pressure roller which forms a second fusing nip by contacting the heating roller;
a frame where the heating roller, the first pressure roller, and the second pressure roller are mounted; and
at least one bending reducing roller which reduces bending of the second pressure roller by supporting a part of the second pressure roller in a lengthwise direction.

2. The apparatus as claimed in claim 1, wherein the second pressure roller has a smaller diameter than the first pressure roller.

3. The apparatus as claimed in claim 1, wherein the at least one of the bending reducing rollers includes a first bending reducing roller,
wherein the first bending reducing roller supports a center part of the second pressure roller in the lengthwise direction.

4. The apparatus as claimed in claim 1, wherein the at least one of the bending reducing rollers includes a first bending reducing roller and a second bending reducing roller,
wherein the first bending reducing roller supports the point that is ⅓ length of the second pressure roller apart from one end of the second pressure roller,
wherein the second bending reducing roller supports the point that is ⅓ length of the second pressure roller apart from the other end of the second pressure roller.

5. The apparatus as claimed in claim 1, wherein an elastic layer is formed on a surface of the at least one of the bending reducing rollers.

6. The apparatus as claimed in claim 1, further comprises:
a support that rotatably supports rotation axis of the at least one of the bending reducing rollers.

7. The apparatus as claimed in claim 6, further comprises:
an elastic member that is connected to the support and the frame and changes power that is applied to the second pressure roller by the bending reducing roller according to the bending of the second pressure roller and the support.

8. The apparatus as claimed in claim 7, wherein the elastic member is installed in a slot which is formed on the frame.

9. The apparatus as claimed in claim 6, wherein the support is installed on the frame.

10. The apparatus as claimed in claim 1, further comprises:
a guide member that is rotatably connected to the frame and guides a process of the printing medium.

11. The apparatus as claimed in claim 10, further comprises:
a support that rotatably supports a rotation axis of the at least one of the bending reducing rollers.

12. The apparatus as claimed in claim 10, further comprises:
an elastic member that is connected to the support and the guide member and changes the power that is applied to the second pressure roller by the bending reducing roller, according to the bending of the second pressure roller.

13. The apparatus as claimed in claim 12, wherein the elastic member is deployed in the slot which is formed on the guide member.

14. The apparatus as claimed in claim 11, wherein the support is installed on the guide member.

15. An image forming apparatus which comprises the fusing apparatus of claim 1.

16. The apparatus as claimed in claim 4, further comprising a first support for the first bending reducing roller that rotatably supports rotation axis of the first bending reducing roller, and a second support for the second bending reducing roller that rotatably supports rotation axis of the second bending reducing roller.

17. The apparatus as claimed in claim 16, further comprises:
a first elastic member that is connected to the first support and the frame and changes power that is applied to the second pressure roller by the first bending reducing roller according to the bending of the second pressure roller and the first support; and
a second elastic member that is connected to the second support and the frame and changes power that is applied to the second pressure roller by the second bending reducing roller according to the bending of the second pressure roller and the second support.

18. The apparatus as claimed in claim 2, wherein if the first and the second pressure rollers are made of the same material, the hardness of the second pressure roller is less than that of the first pressure roller.

19. The apparatus as claimed in claim 6, wherein the support and frame are integrally formed.
